(19) United States
(12) Patent Application Publication
(10) Pub. No.: US 2014/0025406 A1
(43) Pub. Date: Jan. 23, 2014

(54) System and Method for Electronic Identification System

(71) Applicant: ACCUVALLY INC., Taipei City (TW)

(72) Inventors: XIAO-PING ZHANG, Shenzhen City (CN); XIAO-DI FAN, Shenzhen City (CN); YAO-HUEI SIE, New Taipei City (TW); TZU-WEN LO, Puli Township (TW)

(73) Assignee: ACCUVALLY INC., Taipei City (TW)

(21) Appl. No.: 13/798,072

(22) Filed: Mar. 12, 2013

(30) Foreign Application Priority Data
Jul. 20, 2012 (TW) 101126207

(51) Int. Cl. G06Q 20/38

(52) U.S. Cl. CPC G06Q 20/3821
USPC 705/5

(57) ABSTRACT

The present invention relates to a system and method for an electronic identification system to identify formats of electronic certificate and identification. At least one ticket holder can buy an electronic certificate through a web site certified by the electronic identification system and use the electronic certificate to check-in or for identity confirmation. The electronic identification system can also analyze statistical data, verify the electronic certificate, and notify at least one ticket supplier about current attendance and the consumer information immediately.

### BACKGROUND OF THE INVENTION

1. Field of the Invention

The present invention is related to a system and a method for an electronic identification system, more particularly to a system and a method for the electronic identification system which can identify formats of electronic certificate and identification can be completed by at least one terminal validating device in accordance with one of the formats.

2. Description of Related Art

Paper tickets and other identifications are widely adopted to identify for identity or validity of a ticket holder. However, the paper tickets and the identifications can be lost, forged, damaged, duplicate easily. When these happen, it is much more difficult to identify manually, on the other hand, it is easy to infringe the right of the ticket holder. The paper tickets and the identifications are about to become waste and they require expenditure to be manufactured. However, it is a trend for different platforms on the market to exchange and to verify information, for example, the cooperation between social networks and shopping web sites. Nevertheless, the way of original verification in each platform is different, and the system between each platform cannot be integrated easily. Accordingly, the ticket holder requires purchasing or obtaining variety of forms and types of tickets or identifications from individual, uncooperative platform resulting in inconvenience of the ticket holders and then willingness of use diminishing. This is a loss of each platform.

### SUMMARY OF THE INVENTION

For improving the aforementioned disadvantages, the present invention proposes a system and a method for an electronic identification system. The electronic identification system to identify formats of electronic certificate and identification comprises a data storage module, an external payment service module, a notification-service module, a core module, an internal service module, an analysis engine, an advertisement engine, a web site module, an application-program-interface module, a seat module, and at least one terminal validating device. At least one ticket holder can purchase or obtain an electronic certificate through an activity web site or a platform certified by the electronic identification system. A function of the electronic certificate can be similar to the function of a ticket, a membership card, an expenditure certificate, an access control card, or other electronic identifications. After the electronic identification system receives payment information about the payment from the at least one ticket holder or a ticketing notification, the electronic certificate is transmitted to the at least one ticket holder by means of plural ways of wireless communication such as an electronic mail, a text, a Multimedia Media Service (MMS), an Application (App) and the combination thereof. When the at least one ticket holder participates in an activity, tries to identify a member ship, or passes an access control area with a specific identity requiring being demonstrated, the at least one ticket holder can utilize the electronic certificate stored in a portable device with a display function for identification. Identifications, a ticket number, or one identification number also can be identified manually. If necessary, printed paper tickets are used for identification.

As above disclosure, the present invention is able to reduce the expenditure and the waste, to raise correctness for identification, to speed up the identification process. Moreover, the present invention is also able to prevent situations of loss, forgery, damage, duplication of paper tickets and identifications. The at least one ticket holder can purchase or obtain the electronic certificate authorized by the one electronic identification system from different platforms. Information correlated with purchasing or obtaining is stored in the data storage module and can be gathered, exchanged, and integrated between the different platforms. Furthermore, the information correlated with purchasing or obtaining is transmitted to the analysis engine for analyzing and gathering statistics. Results after analyzing and gathering statistics are transmitted to the advertisement engine and then provide advertisers references for choosing a target of an advertisement delivery or other clients and enterprises for utilizing the results.

When being identified by the at least one terminal validating device, content of identification is transmitted to the electronic identification system by an encrypted connection through an internet. That can prevent risks from being modified, forged, raise the safety of the electronic certificate, and identify the electronic certificate accurately. Moreover, the electronic identification system provides another function of instant notifying about a status of entry. When the at least one ticket holder is identified successfully—by the at least one terminal validating device, a real-time check-in notification module instantly notifies at least one ticket supplier about present number of entry and entry information of the at least one ticket holder. This makes the at least one ticket supplier handle the status of entry promptly and manage the activity with ease.

### BRIEF DESCRIPTION OF THE DRAWINGS

FIG. 1 illustrates a block diagram of the electronic identification system.

FIG. 2 illustrates an internal block diagram of the core module of the electronic identification system.

FIG. 3 illustrates a method for the electronic identification system.

### DETAILED DESCRIPTION OF THE INVENTION

Following is a preferred embodiment.

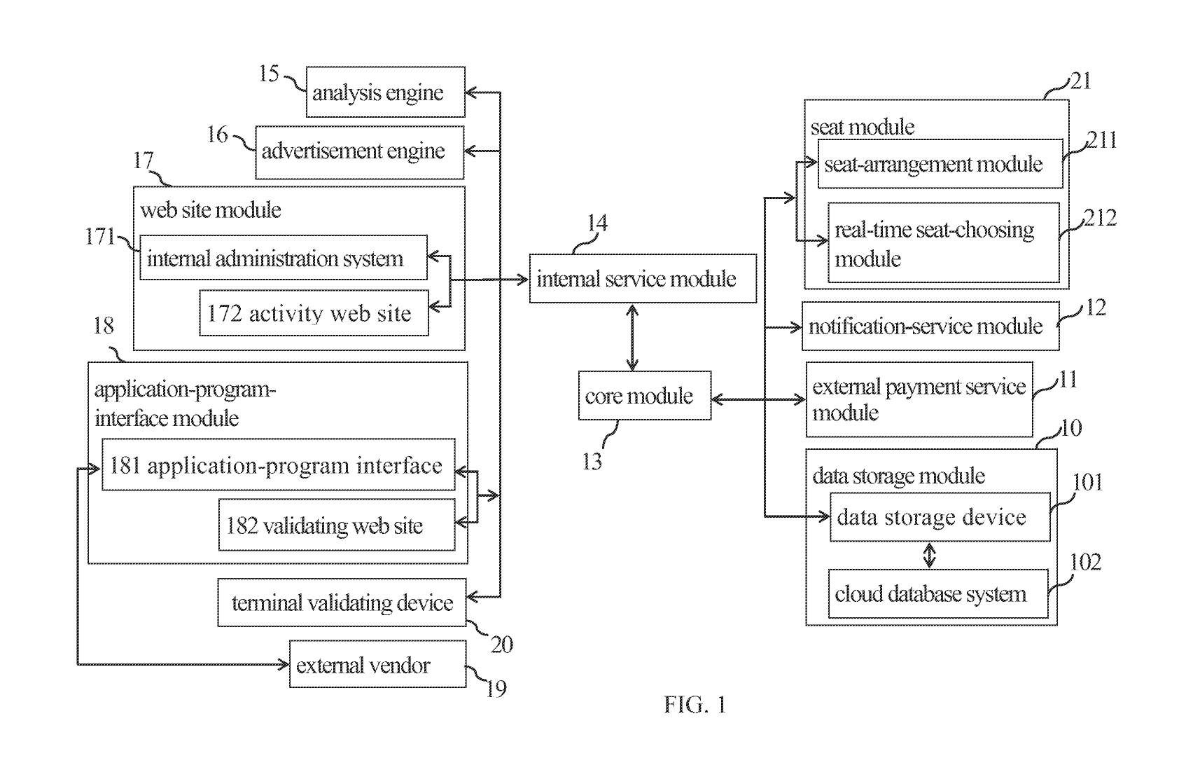

The present invention proposes an electronic identification system to identify formats of electronic certificate and identification. FIG. 1 illustrates a block diagram of the electronic identification system. The electronic identification system comprises a data storage module 10, an external payment service module 11, a notification-service module 12, a core module 13, an internal service module 14, an analysis engine 15, an advertisement engine 16, a web site module 17, an application-program-interface module 18, at least one terminal validating device 20, and a seat module 21.

The data storage module 10 connected with the core module 13 comprises a data storage device 101 and a cloud database system 102. The data storage device 101 is designed for main storage and data are stored in the cloud database system 102 simultaneously for avoiding unpredictable loss of the data. The data storage module 10 possesses the ability to encrypt data for protection and safety in order to prevent personal information and related right of at least one ticket holder from theft or damage.

The external payment service module 11 is connected to the core module 13. When the at least one ticket holder pays by credit card online, in a convenience store, by transferring through an automatic teller machine, by an international online trading platform, by remitting money, or by deducting points on a web site, payment information is transmitted to the core module 13 via the external payment service module 11 in order to generate an electronic certificate, or after the external payment service module 11 receives a ticketing notification sent by at least one external vendor 19, the ticketing notification is transmitted to the core module 13 to generate the electronic certificate. The processes of the at least one ticket holder paying in a convenience store are the following: firstly, the at least one ticket holder chooses a ticket of an activity, the electronic identification system sends a QR code to the at least one ticket holder by an electronic mail, a text, a Multimedia Media Service (MMS), an Application (App) and the combination thereof, while the at least one ticket holder is paying in the convenience store, the QR code showed by the at least one ticket holder can be recognized by a recognition device in the convenience store, finally, the at least one ticket holder pays with the QR code successfully. Afterward, the payment information is transmitted back to the electronic identification system and the electronic certificate can be generated.

The notification-service module 12 is connected to the core module 13. The notification-service module 12 can be a public display module, a text module, a Multimedia Messaging Service (MMS) module, an Application (App) module, an electronic mail module, a real-time web site updating module and the combination thereof. The notification-service module 12 notifies the at least one ticket holder or at least one ticket supplier about information of the electronic certificate, other new activities, purchasing information, or, coupons related to the electronic identification system. When the electronic identification system generates the electronic certificate or requires transmitting the information to the at least one ticket holder or the at least one ticket supplier, the notification-service module 12 transmits the electronic certificate or the information with formats corresponding to and by means of ways, for instance, a public display, the text, the Multimedia Media Service (MMS), the Application (App), the electronic mail, a real-time update of a web site and the combination thereof to notify the at least one ticket holder or the at least one ticket supplier.

The internal service module 14 is connected with the core module 13 and authorizes a partial core function to an internal administration system 171, an activity web site 172, the at least one terminal validating device 20 validated by the electronic identification system, or a platform of the at least one external vendor 19 making those can access the internal information about the electronic identification system such as a purchasing status in one activity, total income of different activities, setting electronic certificate formats.

The analysis engine 15 is connected with the internal service module 14 and uses methods of multi-dimension, specific range and the combination thereof to analyze and to gather statistics of information correlated with the at least one ticket holder purchasing or obtaining the electronic certificate. The information correlated with purchasing or obtaining comprises a history record of purchasing or obtaining, how to pay, participant in other activities, and history information of the at least one ticket holder. Results after analyzing and gathering statistics can assist clients and enterprises to make decisions.

The advertisement engine 16 is connected with the internal service module 14. According to the results from the analysis engine 15, the advertisement engine 16 provides an advertiser a target of an advertisement delivery preciously and concretely, advertises on a screen of the at least one terminal validating device 20, and calculates benefit of the advertisement delivery.

The web site module 17 comprises the activity web site 172 and the internal administration system 171 and is connected to the internal service module 14. The activity web site 172 is a subsidiary web site of the electronic identification system. The at least one ticket holder or the at least one ticket supplier can utilize the activity web site 172 for selling, purchasing, and obtaining tickets. The internal administration system 171 provides staffs of the electronic identification system to inquire, manage, reissue the electronic certificate, to manage transaction record and financial management, to monitor and manage the at least one terminal validating device 20, and to manage the electronic certificate formats.

The application-program-interface module 18 comprises an application-program interface 181 and a validating web site 182 and is connected with the internal service module 14. The application-program interface 181 is connected to the at least one external vendor 19. After authorized and verified by the electronic identification system, the at least one external vendor 19 does not require changing the platform which is presently existing. Moreover, it can utilize functions and services provided by the electronic identification system. The validating web site 182 assists the at least one terminal validating device 20. When the electronic certification of the at least one ticket holder cannot be identified by the at least one terminal validating device 20, the at least one terminal validating device 20 is error, or the at least one ticket holder does not posse the electronic certificate, through the validating web site 182 or logging on the validating web site 182 by an online portable device, the at least one ticket supplier is able to manually identify or to inquire the identity of the at least one ticket holder according to identifications, a ticket number, or one identification number. The process of identification still can be completed under unexpected situation.

The seat module 21 is connected with the core module 13 and comprises a seat-arrangement module 211 and a real-time seat-choosing module 212. The at least one ticket supplier is able to arrange seats of the activity through the seat-arrangement module 211, for example, numbers of rows, the numbers of the seats in one row, or, the seats for Very Important Person (VIP). While the at least one ticket holder purchasing or obtaining the electronic certificate, the real-time seat-choosing module 212, through the platform provided by the at least one external vender 19, provides a function of graphic real-time seat choosing. That makes the at least one ticket holder instantly aware of how many the seats left and how they arranged. The seat about to be purchased or obtained by the at least one ticket holder can be chosen instantly.

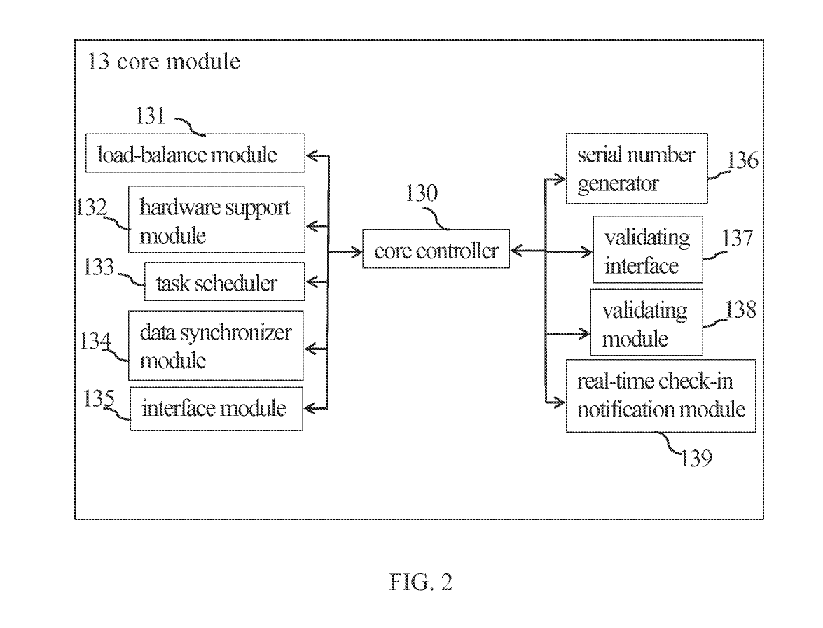

FIG. 2 illustrates the internal block diagram of the core module 13 of the electronic identification system. The core module 13 comprises a core controller 130, a load-balance module 131, a hardware support module 132, a task scheduler 133, a data synchronizer module 134, an interface module 135, a serial number generator 136, a validating interface 137, a validating module 138, and a real-time check-in notification module 139. The core controller 130 controls the load-balance module 131, the hardware support module 132, the task scheduler 133, the data synchronizer module 134, the interface module 135, the serial number generator 136, the validating interface 137, the validating module 138, the real-time check-in notification module 139 and is connected with the internal service module 14.

The load-balance module 131 utilizes distributed netflow and distributed computing technology to raise stability and efficiency of the electronic identification system. The hardware support module 132 provides a hardware-access standard of a transfer protocol, a transfer port, a output and input format for the connection between the at least one terminal validating device 20 and the electronic identification system. The task scheduler 133 schedules every task with sequential order making the electronic identification system able to process large quantity of tasks. The data synchronizer module 134 synchronizes the at least one terminal validating device 20 and the validating module 138 instantly, for the validating module 138 able to update the latest information and status of the identification to further control validity of the electronic ticket or the electronic certificate. The interface module 135 provides resources to the data storage module 10, the external payment service module 11, the notification-service module 12, and the core module 13. The serial number generator 136 generates only one serial number as only one ticket number of each the electronic certificate or as only one identification number of the at least one ticket holder. According to different the at least one terminal validating device 20, the serial number generator 136 can generate the electronic certificate formats. The electronic certificate formats comprise 1D barcode, 2D barcode, Near Field Communication (NFC), Extensible Markup Language (XML) and the combination thereof.

The validating module 138 manages validity of the electronic certificate or identification of the at least one ticket holder all the time, according to a result after identification by the at least one terminal validating device 20.

The validating interface 137 provides validating interfaces corresponding to different electronic certificate formats. The validating interfaces comprises photography recognition, Near Field Communication (NFC), Radio Frequency Identification (RFID), optical identify, biometrics and the combination thereof and makes the at least one terminal validating device 20 able to identify with different electronic certificate formats, fingerprints, or facial recognition. The result after identification by the at least one terminal validating device 20 is transmitted to the validating module 138 via the validating interface 137.

When the at least one ticket holder is successfully identified by the at least one terminal validating device 20, the real-time check-in notification module 139 instantly notifies the at least one ticket supplier about present entry information of the at least one ticket holder, making the at least one ticket supplier instantly grasp the present number of entry and the entry information of the at least one ticket holder through the notification-service module 12 and by the public display which can be an electronic bulletin board or a monitor, by the text, the Multimedia Messaging Service (MMS), the Application (App), the electronic mail, the real-time update of the web site and the combination thereof. The entry information can be the at least one ticket holder as a VIP, a history of expenditure record. According to the forgoing information, the service such as providing discount information, fast leading to the seats, or giving manuals can be supplied. Accordingly, it is the managerial efficiency and the quality of service of the activity that can be raised making the at least one ticket holder and the at least one ticket supplier be willing to utilize the electronic identification system continuously.

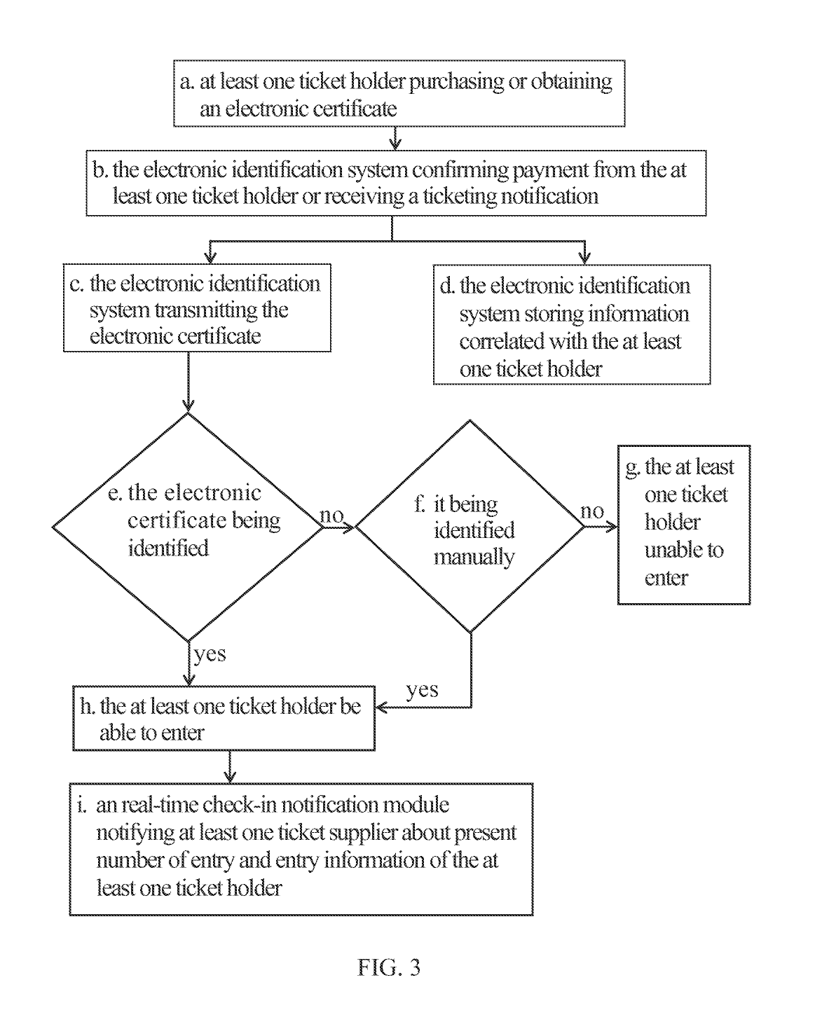

FIG. 3 illustrates a method for the electronic identification system. The method comprises following steps.

In the step a, the at least one ticket holder purchases or obtains an electronic certificate. At least one ticket holder can purchase or obtain the electronic certificate through the platform provided by the at least one external vendor 19 or the activity web site 172.

In the step b, the electronic identification system confirms that the at least one ticket holder pays or receives the ticketing notification. After the at least one ticket holder pays by credit card online, in the convenience store, by transferring through the automatic teller machine, by the international online trading platform, by remitting money, or by deducting points on the web site, the payment information is transmitted to the electronic identification system. The electronic identification system accordingly generates the electronic certificate. Or after the electronic identification system receives the ticketing notification sent by the at least one external vendor 19, then the electronic certificate is generated.

In the step c, the electronic identification system transmits the electronic certificate, at the same time step d being carried out. The electronic identification system transmits the electronic certificate with the formats corresponding to and by means of the electronic mail, the text, the Multimedia Media Service (MMS), the Application (App) and the combination thereof to the at least one ticket holder. The electronic certificate formats comprise 1D barcode, 2D barcode, Near Field Communication (NFC), Extensible Markup Language (XML) and the combination thereof.

In the step d, the electronic identification system stores the information correlated with the at least one ticket holder. The electronic identification system transmits the information correlated with the at least one ticket holder purchasing or obtaining the electronic certificate to the data storage module 10 for storage. The information correlated with the at least one ticket holder purchasing or obtaining the electronic certificate is further transmitted to the analysis engine 15 for analyzing and gathering statistics. The results after analyzing and gathering statistics is transmitted to the advertisement engine 16.

In the step e, the electronic certificate is identified by the at least one terminal validating device 20. If it is identified unsuccessfully, step f is carried out, or the electronic certificate being identified successfully, the step h is carried out. The at least one ticket holder can be identified by the at least one terminal validating device 20 with the electronic certificate, fingerprints, or facial recognition.

In the step f, it is identified manually and the manual identification remains unsuccessful, step g is carried out, or the manual identification turning successful, step h is carried out. It identified by at least one terminal validating device 20 unsuccessfully, through the validating web site 182 or logging on the validating web site 182 by an online portable device, the at least one ticket supplier is able to manually identify or inquire the identity of the at least one ticket holder according to identifications, a ticket number, or one identification number.

g. The at least one ticket holder cannot be able to enter.

h. The at least one ticket holder can be able to enter.

i. The real-time check-in notification module 139 notifies the at least one ticket supplier about the present number of entry and the entry information of the at least one ticket holder. The real-time check-in notification module 139 instantly notifies the at least one ticket supplier about the present number of entry and the entry information of the at least one ticket holder through the notification-service module 12 and by the public display which can be the electronic bulletin board or the monitor, by the text, the Multimedia Messaging Service (MMS), the Application (App), the electronic mail, the real-time update of a web site and the combination thereof.

What is claimed is:

1. An electronic identification system to identify formats of electronic certificates and identifications comprises:
a core module for executing and managing the electronic identification system which generates, transmits, and identify a serial number;
a data storage module for storing and backup data related to the electronic identification system, the data storage module connected with the core module;
an external payment service module for confirming and notifying the electronic identification system about payment information of at least one ticket holder, the external payment service module connected with the core module;
a notification-service module for notifying the at least one ticket holder or at least one ticket supplier about information related to the electronic identification system, the notification-service module connected with the core module;
an internal service module for authorizing a partial core function to a managerial staff or a trusted commercial application;
an analysis engine for using methods of multi-dimension, specific range and the combination thereof to analyze and to gather statistics of information correlated with the at least one ticket holder purchasing or obtaining an electronic certificate, the analysis engine connected to the internal service module;
an advertisement engine providing functions of analyzing and estimating a target of an advertisement delivery, advertising on at least one terminal validating device, calculating benefit of the advertisement delivery and the combination thereof, the advertisement engine connected with the internal service module;
a web site module for an external manager, the at least one ticket holder and the at least one ticket supplier to utilize, the web site module connected with the internal service module;
an application-program-interface module for providing an external interface, the application-program-interface module connected with the internal service module;
at least one terminal validating device connected with the internal service module; and
a seat module for arranging seat and for instantly seat choosing, the seat module connected with the core module.

2. The electronic identification system as claimed in claim 1, wherein the core module comprises a core controller, a load-balance module, a hardware support module, a data synchronizer module, a task scheduler, a validating interface, a validating module, a serial number generator, an real-time check-in notification module, and an interface module for resources access.

3. The electronic identification system as claimed in claim 1, wherein the data storage module comprises a data storage device and a cloud database system.

4. The electronic identification system as claimed in claim 1, wherein the notification-service module comprises a public display module, a text module, a Multimedia Messaging Service module (MMS), an application (App) module, an electronic mail module, a real-time web site updating module and the combination thereof.

5. The electronic identification system as claimed in claim 1, wherein the web site module comprises an internal administration system and an activity web site.

6. The electronic identification system as claimed in claim 1, wherein the application-program-interface module comprises an application-program interface and a validating web site.

7. The electronic identification system as claimed in claim 6, wherein the application-program interface is connected to at least one external vendor and the internal service module.

8. The electronic identification system as claimed in claim 1, wherein the at least one terminal validating device is able to recognize the electronic certificate, a fingerprint, or facial recognition for identification.

9. The electronic identification system as claimed in claim 1, wherein the seat module comprises a seat-arrangement module and a real-time seat-choosing module.

10. The electronic identification system as claimed in claim 2, wherein the real-time check-in notification module instantly notifies the at least one ticket supplier about a status of entry and information of the at least one ticket holder through the notification-service module.

11. The electronic identification system as claimed in claim 2, wherein the hardware support module provides a hardware-access standard of a transfer protocol, a transfer port, an output and input format.

12. The electronic identification system as claimed in claim 2, wherein the serial number generator generates only one serial number as only one ticket number of each the electronic certificate or as only one identification number of the at least one ticket holder.

13. The electronic identification system as claimed in claim 12, wherein an electronic certificate format comprises 1D barcode, 2D barcode, Near Field Communication (NFC), Extensible Markup Language (XML) and the combination thereof.

14. The electronic identification system as claimed in claim 12, wherein the electronic certificate is transmitted to the at least one ticket holder through the notification-service module and by means of an electronic mail, a text, a Multimedia Media Service (MMS), an application (App) and the combination thereof.

15. The electronic identification system as claimed in claim 2, wherein the validating module manages validity of the electronic certificate or identification of the at least one ticket holder.

16. The electronic identification system as claimed in claim 2, wherein the validating interface provides a validating interface corresponding to the electronic certificate format, the validating interface comprising photography recognition, Near Field Communication (NFC), Radio Frequency Identification (RFID), optical identify, biometrics and the combination thereof.

17. A method for an electronic identification system to identify formats of electronic certificates and identifications comprises following steps:
a. at least one ticket holder purchasing or obtaining an electronic certificate;
b. the electronic identification system confirming payment from the at least one ticket holder or receiving a ticketing notification;
c. the electronic identification system transmitting the electronic certificate, at the same time step d being carried out;
d. the electronic identification system storing information correlated with the at least one ticket holder;
e. the electronic certificate being identified by at least one terminal validating device, if it being identified unsuccessfully, step f being carried out, or it being identified successfully, step h being carried out;
f. it being identified manually, the manual identification remaining unsuccessful, step g being carried out, or the manual identification turning successful, step h being carried out;
g. the at least one ticket holder unable to enter;
h. the at least one ticket holder be able to enter; and
i. an real-time check-in notification module notifying at least one ticket supplier about present number of entry and entry information of the at least one ticket holder.

18. The method as claimed in claim 17, wherein in the step b, after the ticket holder pays in a convenience store, by credit card online, by transferring through an automatic teller machine, by an international online trading platform, by remitting money, or deducting points on a web site, payment information is transmitted to the electronic identification system for generating the electronic certificate, or after the ticketing notification sent by the at least one external vendor is received by the electronic identification system, the electronic identification system generates the electronic certificate.

19. The method as claimed in claim 17, wherein in the step c, the electronic identification system transmits the electronic certificate with a format corresponding to and by means of an electronic mail, a text, a Multimedia Media Service (MMS), an Application (App) and the combination thereof, wherein the format of the electronic certificate comprises 1D barcode, 2D barcode, Near Field Communication (NFC), Extensible Markup Language (XML) and the combination thereof.

20. The method as claimed in claim 17, wherein in the step f, it being identified by the at least one terminal validating device unsuccessfully, through a validating web site or logging on the validating web site by an online portable device, the at least one ticket supplier is able to manually identify or inquire the identity of the at least one ticket holder according to identifications, a ticket number, or one identification number.

21. The method as claimed in claim 17, wherein in the step i, the real-time check-in notification module instantly notifies the at least one ticket supplier about present number of entry and entry information of the at least one ticket holder through a notification-service module and by a public display which is an electronic bulletin board or a monitor, by the text, the Multimedia Messaging Service (MMS), the Application (App), the electronic mail, a real-time update of a web site and the combination thereof.
